(19) United States
(12) Patent Application Publication
(10) Pub. No.: US 2018/0309641 A1
(43) Pub. Date: Oct. 25, 2018

(54) METHOD AND SYSTEM FOR SIMULATING A NETWORK TOPOLOGY USING A PHYSICAL MACHINE

(71) Applicants: ESTINET TECHNOLOGIES INC., Hsinchu (TW); National Chiao Tung University, Hsinchu (TW)

(72) Inventors: Shie-Yuan Wang, HSINCHU CITY (TW); I-Yun Lee, Tainan City (TW)

(21) Appl. No.: 15/727,692

(22) Filed: Oct. 9, 2017

(30) Foreign Application Priority Data
Apr. 21, 2017 (TW) 106113462

(51) Int. Cl. H04L 12/24; H04L 12/46

(52) U.S. Cl. CPC H04L 41/145; H04L 41/24; H04L 43/50; H04L 12/4641; H04L 41/08

(57) ABSTRACT

A method and a system are disclosed for simulating a network topology using a physical machine. A physical switch with multiple ports is divided into multiple slice switches according to a network topology. Each slice switch simulates a node in a network. Every virtual port of the slice switch corresponds to a physical port. In simulation operation, a port-mapping table is applied to allow the virtual port to be one-to-one mapped to one physical port; a VLAN conversion table is used to manage the VLAN IDs for the virtual ports and to configure a VLAN tag applied to a simulated packet so that the packet can operate in the slice switch; an output port table is used to determine the output port of the simulated packet; and a pop-off VLAN tag table is used to allow the packet to restore to its original VLAN ID or non-VLAN tag state.

### BACKGROUND OF THE INVENTION

### 1. Field of the Invention

The present invention relates in general to a simulation technology of a network, and more particularly to utilizing physical network devices to simulate nodes of the network so as to simulate a whole network topology.

### 2. Description of Related Art

An amount of tests may be required before actually constituting a real network topology. A network topology is firstly specified. For example, a test of network throughput is used to ensure the throughput under the network topology. Some other tests such as a load capacity test, a transmission rate, and a linking layout test, and a communication protocol operating test, and installation of physical devices are also required.

One of the methods for testing the network topology is to set up a real network with the physical network devices. Although this is the most practicable way of implementing the test, the problems of high cost and inefficiency apparently cannot be avoided. Further, it costs much time to reconfigure the network once the network topology is changed.

Furthermore, using a software emulator to emulate the network topology becomes an efficient way to conduct the test since it saves the cost. The computer-implemented network test is scalable in testing the various network topologies and able to acquire the test result before actually setting up a real network. However, since the software-based network test relies on the capability for processing the network data of the computer hardware, the hardware such as the performance of CPU and memory generally affects the test result. For example, the packets in the emulated network may be unnecessarily delayed or dropped because the insufficient buffer space of the computer holds the backlogged unprocessed packets. Therefore, the test result with respect to the emulated network may show the problems of serious performance fidelity and network scalability.

### SUMMARY OF THE INVENTION

According to one of the embodiments of the system and method for simulating a network topology using a physical machine in accordance with the present disclosure, the simulation method is generally adapted to a physical switch that is configured to simulate the network topology. The method is also applicable to a larger network topology through multiple connected physical switches. Thus, the method can effectively save the cost of using the physical network devices to simulate the real network topology under test. The disclosed method also solves the problem concerning that the hardware limitations will incur the error test result from the software-based emulation.

In the method for simulating the network topology using a physical machine, in one embodiment, a physical switch with multiple physical ports is provided to simulate a plurality of slice switches according to a network topology. Every slice switch includes multiple virtual ports. Each virtual port corresponds to one physical port. In a process of simulation, the physical switch is divided into a plurality of slice switches. One of the slice switches receives a packet; a port-mapping table is applied to identify the slice switch and a corresponding virtual port where the packet enters. The virtual port corresponds to one physical port of the physical switch. A destination of the entering packet can be obtained by parsing the packet. The information of whether or not a VLAN tag is carried by the packet is also parsed. A VLAN conversion table is incorporated for giving a VLAN tag to the packet in accordance with the virtual port receiving the packet. The VLAN tag records a VLAN ID. An output port table is incorporated, and a flow rule is applied to the packet. An output port is determined according to the destination and the given VLAN ID with respect to the packet. Before outputting the packet, the system pops off the given VLAN ID from the packet, and restores the packet to its original state.

Under a different situation, the packet entering a slice switch may already carry an original VLAN ID. In this case, a new VLAN ID is provided to substitute the original VLAN ID. Otherwise, if the packet does not carry any VLAN ID, a VLAN ID is given to the packet.

In the system for network topology simulation, according to one embodiment, a physical switch having multiple physical ports is provided. The system divides the physical switch into a plurality of slice switches according to a desired network topology. Every slice switch also includes a plurality of virtual ports. Every virtual port corresponds to one physical port. To simulate a network, every slice switch is used to simulate a node of the network. Every virtual port is used to simulate a connection port of the node.

In the method using the physical switch to simulate the plurality of slice switches, several lookup tables are provided and stored in non-transitory storage medium. One of the lookup tables records the information such as slice switch numbers and virtual port numbers. A port-mapping table is provided for recording the virtual port number of the slice switch and the corresponding physical port number of the physical switch. A VLAN conversion table is provided and is configured to record a VLAN tag set to the slice switch where a packet enters, in which a VLAN ID is recorded in the VLAN tag corresponding to every virtual port of every slice switch. An output port table is configured to record the destination of a packet and an output port given to the packet corresponding to the VLAN ID according to the destination. A pop-off VLAN-tag table is configured to record the VLAN ID and the original VLAN ID corresponding to the packet.

In one aspect of the method, the quantity and numbers of the multiple virtual ports of every slice switch are dynamically changeable in response to the network topology. For the purpose of simulating a larger network, the network topology can be expanded by assembling multiple physical switches.

### BRIEF DESCRIPTION OF THE DRAWINGS

FIG. 1 shows a schematic diagram depicting a system for simulating a network topology with a physical switch that is used to simulate a plurality of slice switches;

FIG. 2A and FIG. 2B show a schematic diagram depicting an arrangement of multiple connection ports of a slice switch that is simulated by the physical machine in the simulation system;

FIG. 3 shows a schematic diagram depicting a circuitry system in the physical switch of the system in one embodiment of the disclosure;

FIG. 4 shows a flow chart describing a method for simulating the network topology in one embodiment of the disclosure;

FIG. 5 shows another flow chart describing the operation of the system for simulating the network topology in another embodiment of the disclosure;

FIG. 6 shows a diagram showing the curves describing the relationship of achieved throughput and the target throughput obtained from the simulation method in accordance with the disclosure and the conventional software-based emulation;

FIG. 7 shows a diagram showing the throughput deviation curves obtained from the simulation method in accordance with the disclosure and the conventional software-based emulation; and

FIG. 8 shows a diagram showing the CPU usage curves obtained from the simulation method in accordance with the disclosure and the conventional software-based emulation.

### DETAILED DESCRIPTION OF THE PREFERRED EMBODIMENTS

The present invention will now be described more fully with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

The present disclosure is related to a method and a system for simulating a network topology using a physical machine. The technological scheme is to simulate a real network topology by a physical network device. In one aspect, a physical switch with a plurality of connection ports is provided. The physical switch is divided into a plurality of slice switches according to the network topology to be simulated. A number of connection ports of the slice switch and the relationship among the connection ports can be modified as needed. In the method, several lookup tables are provided for converting the physical switch and the ports to the slice switches and the ports, and vice versa. Thus the system can implement a simulation method instead of using a plurality of physical devices to simulate a real network. Further, the system also overcomes the problem concerning that the conventional software-implemented emulation cannot actually simulate the packets traveling among the physical switches since the software-based emulation incurs an inaccurate simulation result as the simulation is restricted by the data-processing capability of the computer.

The object of simulation can be a Software-Defined Network (SDN). SDN is a next-generation network framework. A centralized controller is provided and used to replace a control plane of a conventional switch in a distributed network system. The switch of the SDN is only responsible for processing the data plane, and therefore the performance of the centralized controller can be optimized. For example, the controller of the SDN is optimized to provide a better route arrangement. Further, an OpenFlow protocol is provided to define a standard and public communication channel between the controller and the switches. Through the standard and public protocol, the network, e.g., the SDN, will not be restricted by various rules made by various manufacturers. The network administrator can therefore compose or optimize a controller for implementing a plurality of multi-functional modules for various applications.

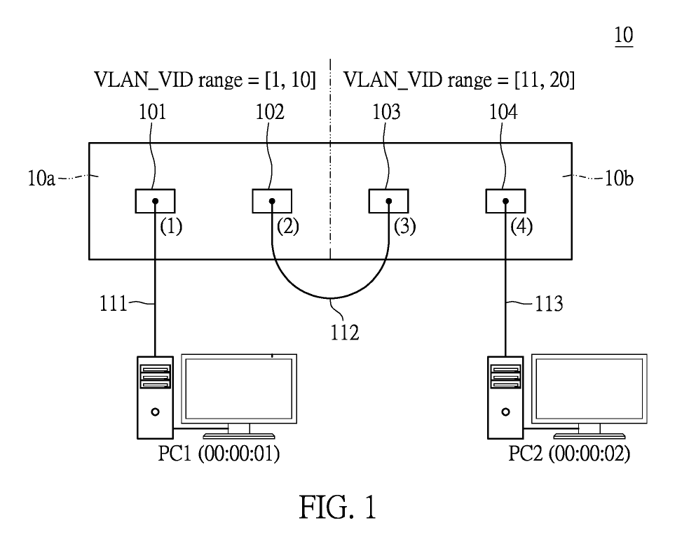

To constitute a system for simulating a network topology using a physical machine, at least one physical switch is prepared. A network topology to be simulated is firstly given. A number of slice switches and the multiple virtual ports of each slice switch should be defined according to a number of nodes, e.g., the switches, and their connection relationships of the network topology. An example is exemplified as the network topology of the system schematically shown in FIG. 1.

As FIG. 1 shows, a physical switch 10 is provided for simulating a network topology. The shown physical switch 10 has four physical ports, e.g., the ports 101, 102, 103 and 104, numbered as 1, 2, 3 and 4. The physical switch 10 is used to create two slice switches for simulating the network topology with two switch nodes. According to the connections between the nodes, the physical ports 101, 102, 103 and 104 of the physical switch 10 are divided into two slice switches. The two slice switches are represented by a first slice switch 10a and a second slice switch 10b. Every slice switch (10a or 10b) is used to simulate one node of the network.

In the current example, the four physical ports 101, 102, 103 and 104 are divided into two groups according to the connection relationship of the network to be simulated. The first slice switch 10a includes the connection ports 101 and 102. The corresponding virtual port numbers can be renumbered as needed. The second slice switch 10b includes the connection ports 103 and 104. The corresponding virtual port numbers can also be renumbered. The virtual ports of every slice switch (10a or 10b) are one-to-one mapped to two of the physical ports 101, 102, 103 and 104. A port-mapping table is incorporated. The port-mapping table is used to store numbers of multiple virtual ports of every slice switch and numbers of multiple physical ports of the physical switch. The port-mapping table allows the system to inquire the correspondence among the virtual and physical ports and refer to conversion among the ports. To solve the possible conflicting problem when hosting multiple slice switches on an SDN switch, a scheme for mapping between the port number used in the slice switch and the port number used in the original switch is used. The scheme gives each slice switch a different and non-overlapping range of VLAN ID space, e.g., the shown VLAN_VID range=[1, 10] and the VLAN_VID range=[11, 20] for each slice switch.

The connection port 101 of the first slice switch 10a connects to a terminal device PC1 (MAC address: 00:00:01) via a physical wire 111. The connection port 102 of the first slice switch 10 is connected to the connection port 103 of the second slice switch 10b via a physical wire 112. The connection port 104 of the second slice switch 10b is connected to a terminal device PC2 (MAC address: 00:00:02) via a physical wire 113. When the physical connectivity has been completed, the network topology with two interconnected switches (10a, 10b) and two terminal devices (PC1, PC2) is under simulation by the system. In an exemplary example, a packet is configured to be transmitted from the terminal device PC1 to the terminal device PC2. In the physical switch 10, the packet launches from the terminal device PC1, passes through the physical wires 111, 112 and 113 between the first slice switch 10a and the second slice switch 10b, and arrives at the terminal device PC2. It is worth noting that the transmission of the packet through the physical network device and connections, e.g., RJ-45 or fiber, can actually reflect the actual condition of the real network.

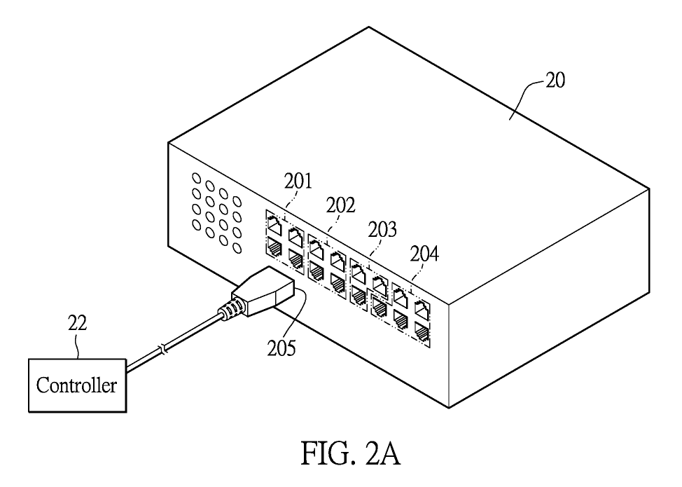

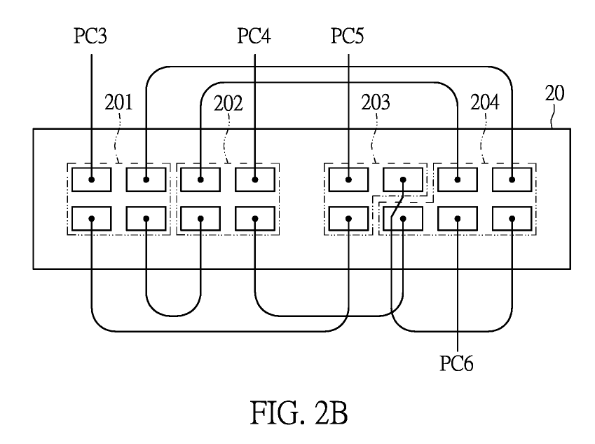

In one embodiment, the physical switch includes multiple physical ports that are divided for simulating multiple slice switches according to the network topology to be simulated. The slice switches may have the same or different numbers of virtual ports. The virtual ports of each slice switch are one-to-one mapped to the physical ports of the physical switch. In one embodiment, a quantity and numbers of the multiple virtual ports of every slice switch are dynamically changeable in response to the network topology. References are made to FIG. 2A and FIG. 2B schematically showing a port arrangement in a physical switch.

FIG. 2A shows a physical switch 20 that is a 16-port switch. The 16-port switch is used to simulate multiple slice switches (201, 202, 203 and 204), that is a first slice switch 201 with four ports, a second slice switch 202 with four ports, a third slice switch 203 with three ports, and a fourth slice switch 204 with five ports. The number of the connection ports for every slice switch is determined based on the network topology to be simulated. It is not necessary for the slice switches (201, 202, 203 and 204) to have the same number of virtual ports. A management interface 205 is provided in the physical switch 20. The management interface 205 connects with an external computer and allows the administrator to set up the physical switch 20. For an SDN, the management interface 205 is used to connect with an SDN controller 22 that is specified to the SDN. The management interface 205 is used to simulate a plurality of connections between the slice switches (201, 202, 203 and 204) and the controller 22 according to the number of the slice switches (201, 202, 203 and 204), and each connection is identified by a network ID. In the current example, the physical switch 20 simulates four slice switches (201, 202, 203 and 204). Accordingly, four connections between the management interface 205 and the SDN controller 22 are simulated. Each simulated connection corresponds to one slice switch. An IP address or an ID can be used to identify every connection.

The remote controller 22 connects with every slice switch via one simulated connection. Every slice switch can be a standalone switch that operates its independent task under a specific communication protocol. Every standalone slice switches (201, 202, 203 and 204) will not be influenced by others. In the method, the controller 22 can still operate under its original design, e.g., operating under the OpenFlow protocol, since the controller 22 regards the connected slice switches as the physical switches.

The system for simulating the network topology using the physical machine is scalable since the network topology can be expanded by assembling multiple physical switches. The multiple physical switches can simulate more slice switches that can be interconnected via multiple physical connections. The slice switches connect with the controller 22 via multiple simulated connections by one or more management interfaces. The controller 22 controls the slice switches via the physical connections that are used to connect with the physical switches.

A front panel of the physical switch 20 is schematically shown in FIG. 2B. There are 16 physical ports disposed on the panel. The physical ports can be divided for simulating multiple slice switches (201, 202, 203 and 204). The slice switches (201, 202, 203 and 204) are interconnected via one or more physical connections, e.g., the RJ-45 or fiber. The diagram also shows that the slice switches (201, 202, 203 and 204) connect with the terminal devices (PC3, PC4, PC5 and PC6) respectively. The slice switches (201, 202, 203 and 204) are divided from the physical switch 20. Every slice switch simulates the SDN switch in accordance with the present disclosure.

It should be noted that only the slice switches and virtual ports thereof being required to be reconfigured for the original network topology are changed. The slice switches and virtual ports thereof can be reconfigured by renumbering the virtual port numbers and modifying the port-mapping table that records the one-to-one connection relationship between the physical ports and the virtual ports. Therefore, the physical connections among the physical/virtual ports need not be changed even if the network topology is changed. Compared to the conventional network system or the software-based simulation of the network, the simulation system in accordance with the present disclosure provides an easier and faster way to respond to the change of the network topology by modifying various lookup tables. It is noted that it is not easy for the conventional network system to change its network topology, and the software-based simulation of the network requires reconfiguring the test method so as to respond to any change of the network topology.

In the simulation system, a control circuit for processing the incoming and outgoing packets is installed in the physical switch. The control circuit is such as a control circuit for network physical layer (PHY) that is used to control operations of the connection ports. While the system simulates a specific network topology, the packets transmitted among the connection ports and the different slice switches operate in a line rate.

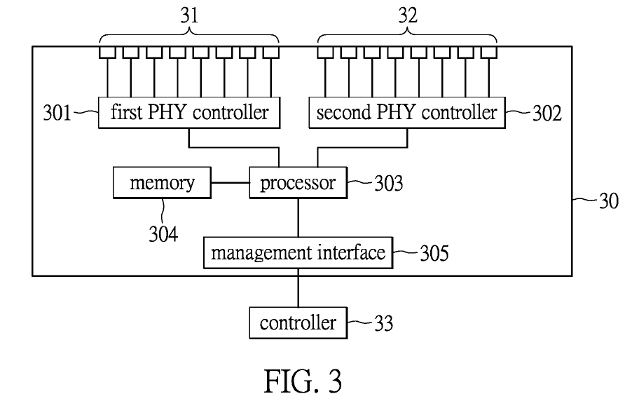

FIG. 3 shows a block diagram describing a circuit system of the physical switch in one embodiment of the present disclosure. One of the circuit components of a physical switch 30 is a processor 303 that is used to process the packets incoming and outgoing among physical ports 31 and 32. The processor 303 executes the simulation instructions according to the configuration of the virtual ports for simulating the network topology. The processor 303 is also used to manage the operation of PHY controllers 301 and 302 of multiple physical ports 31 and 32 of the physical switch 30. The first PHY controller 301 and the second PHY controller 302 respectively control a plurality of physical ports (31) and physical ports (32). In the current example, the first PHY controller 301 controls eight connection ports, and the second PHY controller 302 controls the other eight connection ports. Every physical port is used to connect to one network device.

The first PHY controller 301 and the second PHY controller 302 are respectively given their unique PHY IDs. Every physical port (31 or 32) has its own interface ID, e.g., the port number. While the physical switch 30 is in operation, the packet transmitted through the connection ports will carry the information such as the PHY IDs and interface IDs corresponding to the sources and destinations. In particular, when the physical switch is divided into several slice switches, those PHY IDs and interface IDs allow the packet to be transmitted among the connection ports and the slice switches.

It is worth noting that, when the slice switches are used to simulate the network topology, the incoming and outgoing packets among the slice switches are processed by the first PHY controller 301 and the second PHY controller 302. The controllers (301, 302) are used to perform the processes such as packet matching, forwarding and transmission. Under this scheme, a specific line rate can be implemented over the physical connections, but not be affected by the data processing capability of the physical switch 30. Therefore, the system for simulating the network topology in accordance with the present disclosure retains a high accuracy of the test since the simulation will not be restricted by the hardware limitation of the processor 303 of the physical switch 30.

In the method for simulating the network topology with the physical switch 30 in accordance with the present disclosure, the two sets of physical ports 31 and 32 of the physical switch 30 can be divided for simulating the virtual ports associated to the multiple slice switches. The virtual ports are required to be renumbered. The information such as the numbers of the virtual ports and their corresponding physical port numbers is stored in a memory 304. In one aspect of the disclosure, the memory 304 of the physical switch 30 is non-transitory storage medium, and can be an external storage. The memory 304 is electrically connected with the processor 303. The data stored in the memory 304 includes operating programs for performing the simulation method that are executed by the processor 303. The data in the memory 304 also includes the information such as slice switch numbers and the virtual port numbers that are used to conduct the method. The above-mentioned scheme implements a set of conversion logics that allow the system to operate multiple slice switches using one or more physical switches. One of the approaches is to provide several lookup tables. The lookup tables can effectively prevent the conflictions when the flow rules running in the multiple slice switches are operated in one physical switch at the same time.

The physical switch 30 has a management interface 305 for connecting with the external devices. The management interface 305 is electrically connected with the processor 303. The management interface 305 is used to connect with the controller 33 of the network topology. The controller 33 controls the multiple slice switches simulated by the physical switch 33 according to the slice switch numbers.

According to one of the embodiments of the simulation method, the slice switches have their own flow rules. The flow rule records the information regarding an output port in response to the destination of the packet. The flow rule allows the system to determine an output port according to the destination parsed from the incoming packet and the given VLAN ID. For example, in FIG. 1, the two slice switches 10a and 10b respectively connected to the terminal devices PC1 and PC2 form a network topology. The topology forms consecutive connections among the terminal device PC1, the first slice switch 10a, the second slice switch 10b, and the terminal device PC2.

For example, a packet is created in the terminal device PC1 and configured to be transmitted to the terminal device PC2. The flow rule of the first slice switch 10a is used to know that the destination is the terminal device PC2 connected to the second slice switch 10b, and determine that the packet is forwarded through the connection port 101 and outputted via the connection port 102. When the second slice switch 10b receives the packet via the connection port 103, the second slice switch 10b knows that the destination is the terminal device PC2 by parsing the packet. A flow rule of the second slice switch 10b is used to output the packet to the terminal device PC2 via the connection port 104.

It should be noted that the flow rule of the first slice switch 10a and the flow rule of the second slice switch 10b cannot be stored in the same flow table since the flow rules of different switches may conflict with each other and the processor of the physical switch cannot deal with the flow rules in confliction. A mechanism of new port numbers or IDs is therefore introduced. The mechanism that allows the system to renumber the connection ports in the slice switches is incorporated in the simulation system.

The connection ports of the physical switch are firstly given port numbers such as the mentioned interface IDs, and then the connection ports in the slice switches are given the VLAN IDs. For overcoming the confliction among the slice switches, each slice switch is also given a unique range of the VLAN IDs for its ports. Therefore, the packet will be given a port number and a VLAN ID when it passes through every slice switch. The packet can be successfully forwarded among the slice switches based on the information of the ports and the VLAN IDs recorded in the lookup tables.

Each slice switch is configured to have a unique switch ID, e.g., a slice switch number. The slice switch provides a routing function, and the slice switch numbers for the slice switches are referred to as the datapath IDs for identifying the routing paths while the packet is forwarded in the slice switches. Every slice switch has a datapath ID that allows the controller to identify the slice switch. The virtual ports in every slice switch are configured to have the virtual port numbers, e.g., vport1, vport2, etc. The virtual port numbers may be renumbered starting from 1 or 0. Every virtual port number corresponds to one physical port number, e.g., port1, port2, etc. The correspondences between the virtual port numbers and the physical port numbers are recorded in a port-mapping table. The port-mapping table is used to store numbers of multiple virtual ports of every slice switch and numbers of multiple physical ports of the physical switch.

The controller of the system is such as the SDN controller. For the controller, every connected slice switch is an independent and distinct switch. Every slice switch has its own flow rules. Within a specific network topology, there is a connection relationship between the slice switches. Therefore, a forwarding flow rule will be formed based on the two flow rules of the two slice switches. The forwarding flow rule is recorded in a bridging flow table that is stored in the memory of the physical switch. The bridging flow table records at least one destination address, e.g., an IP address or a port number, and VLAN IDs. The destination and a VLAN ID will be carried in a header of the packet.

Each slice switch is given a certain range of non-overlapped VLAN IDs different from other slice switches. The distinct range of VLAN IDs allows the system to identify the flow rule of the slice switch in the bridging flow table. In practice, the range of VLAN IDs can be flexibly adjusted. If the field of VLAN ID recorded in the bridging flow table and the packet header has 12 bits, the number of available VLAN IDs reaches 2¹²=4096, which is sufficient to allocate the distinct ranges of VLAN IDs to the different slice switches.

Still referring to FIG. 1, the example shows two slice switches (10a, 10b) divided from one physical switch. The example shows the range of VLAN IDs of the first slice switch 10a is given 1 to 10 ([1,10]), and the range of VLAN IDs of the second slice switch 10b is given 11 to 20 ([11,20]). When the packet entering one of the slice switches does not carry any VLAN ID, namely no VLAN tag is carried by the packet; the system will push a VLAN tag into the packet header and also give the packet a VLAN ID according to the range of VLAN IDs of the slice switch where the packet enters. This scheme allows the entering packet without a VLAN tag to match the flow rule recorded in the bridging flow table by the given VLAN tag. Therefore, the flow rule of the slice switch can be applied to the entering packet. The port-mapping table recording the conversion between the virtual ports and the physical ports is also applicable to the entering packet. The flow rules of the slice switches will not be in confliction because different slice switches are given different ranges of VLAN IDs.

The slice switch parses the header of the entering packet so as to acquire destination information. The system determines the virtual port number of an output port and forwards the packet to be outputted from the current slice switch according to the destination information. Before the packet leaves a processing pipeline of the current slice switch, the system will pop off the pushed VLAN tag and restore the packet back to its original state. The packet is then outputted from the slice switch.

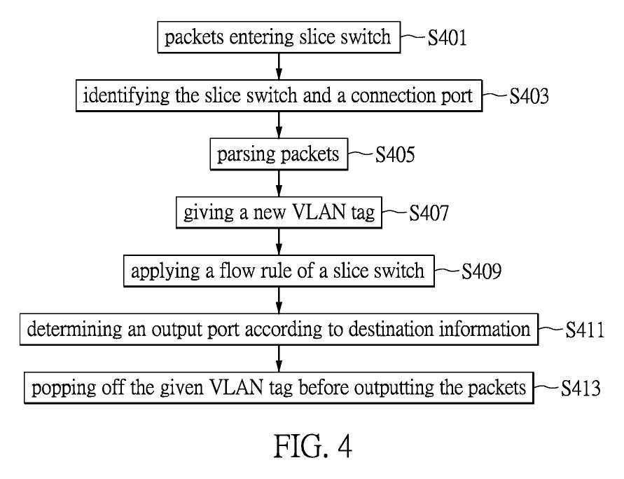

The simulation method can be referred to in the flow chart shown in FIG. 4.

A packet enters a node of a network under test in step S401. The node of the network is such as a slice switch divided from a physical switch. A port-mapping table shown as Table 1 is applied to identify the slice switch receiving the packet and the corresponding virtual port, as in step S403. The Table 1 records the numbers of the virtual ports of the slice switch and their corresponding numbers of the physical ports of the physical switch. For example, the physical ports are numbered as 1, 2, 3 and 4 that correspond to the renumbered virtual port numbers 1/1, 1/2, 2/1 and 2/2 respectively to the slice switches 10a and 10b. In the current example, the physical ports numbered as 1 and 2 are for the first slice switch, and the physical ports numbered as 3 and 4 are for the second slice switch.

A previous code ‘1’ of ‘1/1’ in the second column indicates the first slice switch 10a. A later code ‘1’ of ‘1/1’ in the second column indicates the first port number of the first slice switch 10a. Similarly, a previous code ‘1’ of ‘1/2’ indicates the first slice switch 10a, and the later code ‘2’ of ‘1/2’ indicates the second port number of the first slice switch 10a. Further, a previous code ‘2’ of ‘2/1’ in the second column indicates the second slice switch 10b, and the later code ‘1’ of ‘2/1’ indicates the first port number of the second slice switch 10b. Still further, a previous code ‘2’ of ‘2/2’ indicates the second slice switch 10b, and the later code ‘2’ of ‘2/2’ indicates the second port number of the second slice switch 10b.

TABLE 1

| physical port number | slice switch/virtual port number |
|---|---|
| 1 | 1/1 |
| 2 | 1/2 |
| 3 | 2/1 |
| 4 | 2/2 |

In step S405, a software-based process operating in the switch parses the entering packet and obtains the information of destination and whether or not the packet carries a VLAN tag. In step S407, a VLAN conversion table shown in Table 2 is applied to push a VLAN tag to the simulated packet entering the slice switch. Applying the VLAN conversion table for giving the packet the new VLAN tag is in accordance with operation of the slice switch in the system. The VLAN conversion table ensures that the packet can be successfully forwarded in the system to the destination. The VLAN conversion table is configured to record a VLAN tag set to the slice switch where a packet enters, and store a VLAN ID, recorded in the VLAN tag, corresponding to every virtual port of every slice switch. The first column of Table 2 records physical port numbers 1, 2, 3 and 4, and the second column is used to record if the header of the packet records any VLAN ID. When the second column of the Table 2 is filled with ‘-’, it shows non-VLAN tag state that means no VLAN tag is carried in the header of the packet. When the second column is not filled with ‘-’, it shows that an original VLAN ID has been set in the entering packet. When the value of second column is ‘1’, it shows that the original VLAN ID of the packet is ‘1’ entering from a physical port. The information of the third column of Table 2 indicates that a new VLAN ID is pushed to the packet or is used to replace the original VLAN ID. In the current example, the first virtual port of the first slice switch ‘1/1’ corresponds to the physical port number ‘1’. If the entering packet has no VLAN ID, indicated by the filled in the second column of the Table 2, the system will push a new VLAN ID ‘1’ to the packet. On the contrary, if the packet entering the first slice switch via the virtual port ‘1/1’ corresponding to the physical port number ‘1’ has carried an original VLAN ID ‘1’, the system will use a new VLAN ID ‘2’ to replace the original VLAN ID ‘1’ of the packet. While the Table 2 is applied, the VLAN ID ‘1’ and the VLAN ID ‘2’ are for the internal use of the first slice switch. The VLAN ID ‘11’ and the VLAN ID ‘12’ are for the internal use of the second slice switch. Before the packet leaves the first slice switch or the second slice switch, the system will pop off the pushed VLAN ID or restore the modified VLAN ID to its original VLAN ID according to the Table 2.

It should be noted that the system provides a new VLAN ID to substitute the original VLAN ID of the packet if the entering packet has carried the original VLAN ID. The system prevents the given VLAN ID from being reduplicated with the VLAN ID in use, namely each slice switch is configured to have a range of multiple VLAN IDs and the ranges of VLAN IDs do not overlap with those of other slice switches.

TABLE 2

| physical port number | original VLAN ID | VLAN ID |
|---|---|---|
| 1 | — | 1 |
| 1 | 1 | 2 |
| 2 | — | 1 |
| 2 | 1 | 2 |
| 3 | — | 11 |
| 3 | 1 | 12 |
| 4 | — | 11 |
| | 1 | 12 |

When the entering packet is pushed with a new VLAN ID, the packet then belongs to the given VLAN. A corresponding flow rule is then applied to the packet that enters the slice switch. Table 3 shows an output port table that is configured to record a destination of a packet and an output port given to the packet corresponding to the VLAN ID according to the destination. The flow rule allows the system to process the packet with its new VLAN ID, as in step S409. The flow rule is recorded in the bridging flow table stored in the memory of the physical switch. The flow rule is used to determine an output port according to the destination parsed from the entering packet.

In step S411, the destination information can be parsed from the packet. The destination is exemplified as the terminal device PC1 (MAC address: 00:00:01) or the terminal device PC2 (MAC address: 00:00:02) shown in FIG. 1. When a flow rule is applied to the packet, in view of the Table 3 and Table 2, an output physical port can be determined according to the destination and the VLAN ID.

For example, references are made to Table 3 and the embodiment shown in FIG. 1. When the destination of the packet is the terminal device PC1 (MAC address: 00:00:01) and its new VLAN ID is ‘1’, the output physical port will be the port with number ‘1.’ When the destination of the packet is the terminal device PC1 (MAC address: 00:00:01) and its new VLAN ID is ‘11’, the output physical port will be the port with number ‘3.’ When the destination of the packet is the terminal device PC2 (MAC address: 00:00:02) and its new VLAN ID is ‘1’, the output physical port will be the port with number ‘2.’ When the destination of the packet is the terminal device PC2 (MAC address: 00:00:02) and its new VLAN ID is ‘12’, the output physical port will be the port with number ‘4.’

TABLE 3

| destination | VLAN ID | output port number |
|---|---|---|
| 00:00:01 | 1 | 1 |
| 00:00:01 | 2 | 1 |
| 00:00:01 | 11 | 3 |
| 00:00:01 | 12 | 3 |
| 00:00:02 | 1 | 2 |
| 00:00:02 | 2 | 2 |
| 00:00:02 | 11 | 4 |
| 00:00:02 | 12 | 4 |

Finally, such as in step S413, before the packet passes through the output physical port, the system pops off the given VLAN ID and restores back to its original VLAN tag or non-VLAN tag state. The original content of the packet will be completely retained. Table 4 is used to perform the pop-off and restoration processes. Table 4 is a pop-off VLAN-tag table that is configured to record every VLAN ID and a corresponding original VLAN ID associated with the packet. Table 4 shows a reversed correspondence of Table 2. The first column of Table 4 records the VLAN IDs of the slice switch. In the current example, the VLAN IDs are exemplified as ‘1’, ‘2’, ‘11’ and ‘12.’ The pop-off process restores the packet to have its original VLAN IDs ‘1’, and ‘1.’ The symbol on the second column indicates that the pushed VLAN ID of the packet will be restored to its non-VLAN tag state. The VLAN ID ‘1’ on the second column means that the packet with the modified VLAN ID ‘2’ or ‘12’ after it enters the slice switch will be restored back to its original VLAN ID ‘1’ before it leaves the slice switch.

TABLE 4

| VLAN ID | original VLAN ID |
|---|---|
| 1 | — |
| 2 | 1 |
| 11 | — |
| 12 | 1 |

The packet is then outputted via an output port. If the packet is then forwarded to the other slice switches, the procedure described in FIG. 4 will be repeated. Accordingly, a new set of port-mapping table, VLAN conversion table, output port table and pop-off VLAN-tag table will be re-applied to the packet that enters the other slice switches.

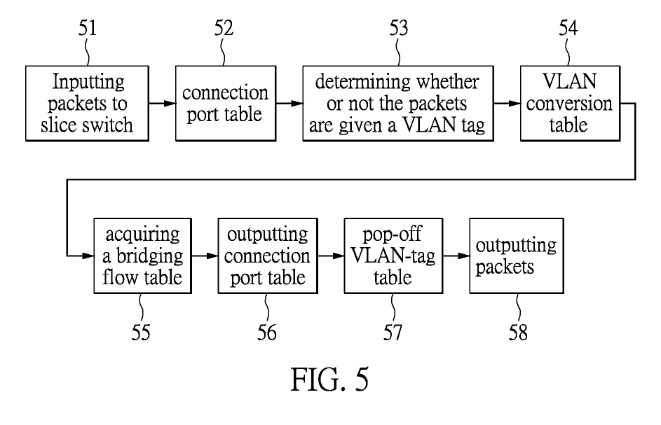

Reference is made to FIG. 5 showing a flow chart that describes the operation of the simulation system in one embodiment of the present disclosure. The flow chart describes the process when a packet enters the slice switches that are simulated with a physical switch. The physical switch is divided into multiple slice switches for simulating a network topology. The packet is launched by a terminal device connected to the network, e.g., a Software-Defined Network. A controller connected to the physical switch controls a whole operation of the system, namely the SDN controller can connect with the slice switches via physical or virtual connections and controls the flow rules of every slice switch.

In the beginning, the terminal device generates the packet. The packet enters the network via a virtual port of one of the slice switches, such as in step 51. A VLAN ID, a source address and a destination address can be obtained by parsing the header of the packet. The simulation system is implemented through a circuit system inside the physical switch. A port-mapping table is incorporated, such as in step 52. The port-mapping table records the virtual port receiving the packet and its corresponding physical port.

Next, the system determines whether or not the packet carries an original VLAN tag, such as in step 53. The original VLAN tag may be given to the packet by a previous network device. Without changing the original content of the packet, the system incorporates a VLAN conversion table, such as in step 54. If the packet does not carry any VLAN tag, the system pushes a new VLAN tag to the packet in response to the virtual port receiving the packet. The VLAN conversion table is used to push a new VLAN tag. If the packet has carried an original VLAN tag, the system uses a new VLAN ID to substitute its original VLAN ID in response to the virtual port receiving the packet. The information regarding the correspondence between the pushed VLAN tag and the original VLAN tag is buffered in a memory.

A bridging flow table is then applied, such as in step 55. The bridging flow table can be retrieved from the SDN controller or a memory of the physical switch. When a flow rule of the slice switch is applied, the system operates with the new pushed VLAN ID. An output port table is used to determine an output port according to the destination and the given VLAN ID, such as in step 56. Before the packet is outputted, the system pops off the given VLAN tag according to the pop-off VLAN-tag table, such as in step 57, and restores the packet to its original state such as its non-VLAN tag state or its original VLAN ID. The packet with its original content is then outputted, such as in step 58.

The following charts show the experimental results that are used to demonstrate the advantage of using a physical machine to simulate a network topology in accordance with the present disclosure as it compares with the method of the conventional software emulation.

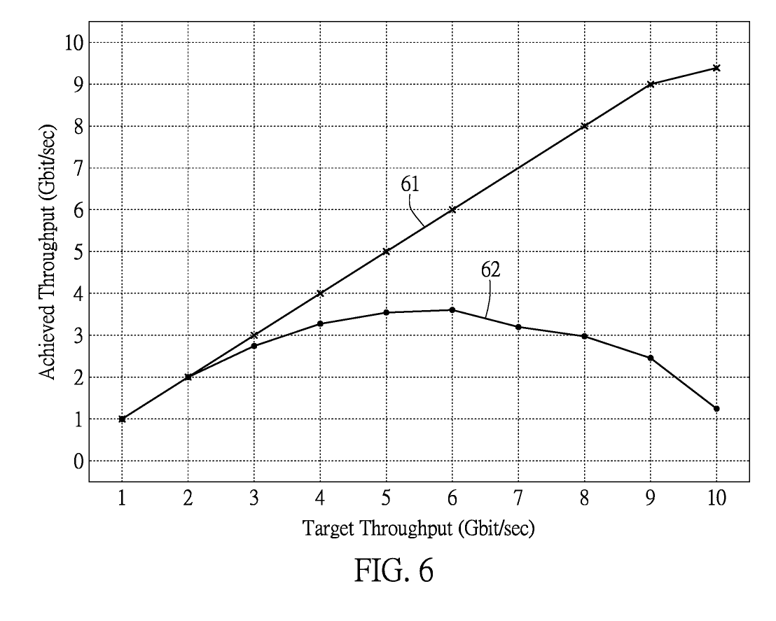

FIG. 6 is a chart showing two curves that indicate the achieved throughputs respectively measured by the simulation system using the physical machine and by the software-based emulation under different target throughputs. The experimental results of the average achieved throughputs were based on six TCP flows in a 300-second period.

The vertical axis of the chart represents the average achieved throughputs (Gbit/sec), and the horizontal axis represents the target throughputs (Gbit/sec). An achieved throughput curve 61 is measured by the system for simulating the network topology using the physical machine in accordance with the present disclosure. The achieved throughput curve 61 shows that the achieved throughputs increase greatly with the increment of the target throughputs, and almost proportional to the target throughputs. The achieved throughput curve 61 shows that the simulation system can correctly reflect the actual condition of the network. On the contrary, the achieved throughput curve 62 shows that the achieved throughputs simulated by the software-based emulation cannot increase with the increment of the target throughputs even though the curve 62 increases in the beginning. When the target throughput reaches 6 Gbit/sec, the achieved throughput curve 62 descends. The achieved throughput curve 62 shows that the software-based emulation cannot correctly reflect the actual condition of the network to be simulated. The software-based emulation gets stuck when it reaches a high target throughput.

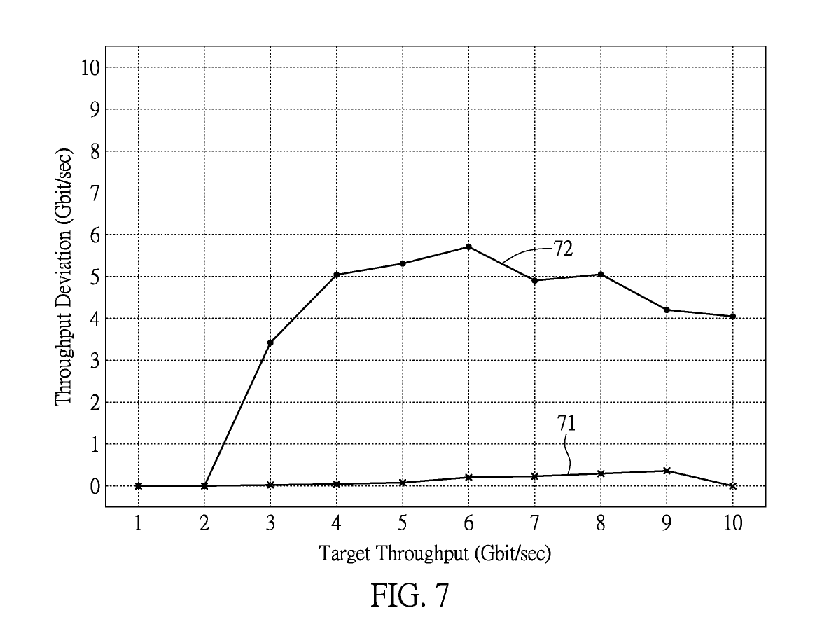

FIG. 7 is a chart showing two throughput deviation curves that respectively show the deviations when the simulation system and the software-based emulation perform network simulation. The vertical axis represents the throughput deviation (Gbit/sec) and the horizontal axis represents the target throughput (Gbit/sec).

The chart shows that the throughput deviation curve 71 made by the simulation system using the physical machine retains in a small amount of deviation with the target throughput increases. The chart also shows the throughput deviation curve 72 made by the software-based emulation stays a status with high throughput deviation. Therefore, the system for simulating the network topology using the physical machine in accordance with the present disclosure does not produce excessive throughput deviation even though it simulates a higher target throughput of the network. Therefore the simulation system provides a better simulation approach.

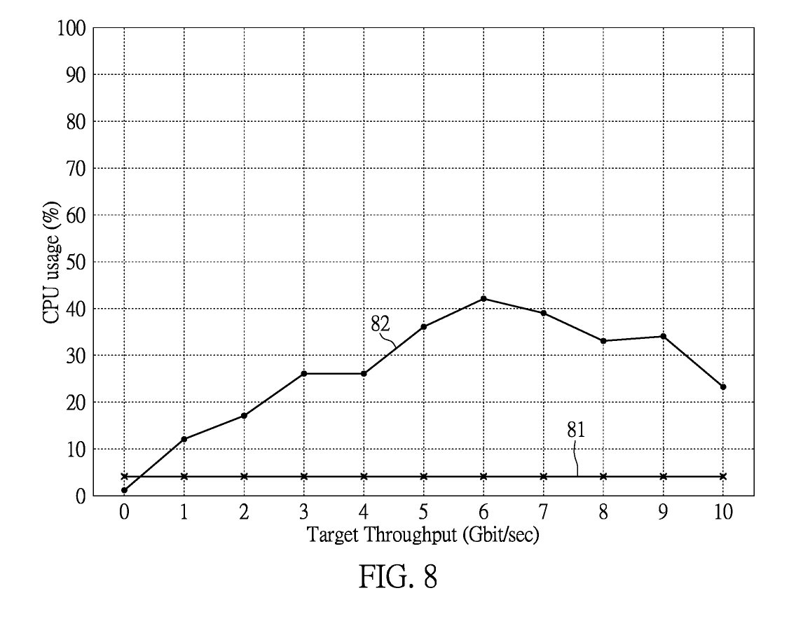

FIG. 8 is another chart showing the CPU usage curves with respect to the simulation system using the physical machine and the software-based emulation. The vertical axis represents the percentage of CPU usage (%) and the horizontal axis represents the target throughput (Gbit/sec).

The conventional software-based emulation is operating in a computer system. The simulation relies on the processing capability of the CPU and performance of the memory or buffer of the computer. However, the hardware performance will decrease as the amount of data increases. The CPU usage curve 82 made by the software-based emulation shows that the emulation costs a high CPU usage (%) and the CPU usage varying with the target throughput increases. As compared to the conventional software-based emulation that may output incorrect simulation result because its hardware strongly affects its simulation performance, the network simulation running in the simulation system will not be influenced obviously with the target throughput that increases since the simulation system is a hardware-based system using the physical switch that is originally designed for processing the network packets. As the CPU usage curve 81 shows, the CPU usage of the simulation system retains at a low level even though the system simulates a high target throughput.

To sum up, the simulation system of the present disclosure utilizes a physical switch to run multiple slice switches for simulating the network topology. The system has scalability for expanding its simulated network topology using one or more physical switches. The hardware-based simulation method and system provide a stable and a high performance network simulation according to the experimental data, and also achieve a low-cost solution in which a physical machine is used to simulate the multiple switches of the network applicable to overcome the problems that the software-based emulation would encounter.

It is intended that the specification and depicted embodiments be considered exemplary only, with a true scope of the invention being determined by the broad meaning of the following claims.

What is claimed is:

1. A method for simulating a network topology using a physical machine, wherein the method is adapted to a system with a physical switch having a plurality of physical ports, in which the physical switch is divided into multiple slice switches according to a topology, every slice switch includes a plurality of virtual ports in which every virtual port corresponds to a physical port, every slice switch simulates a node of a network, and every virtual port simulates a connection port of the node; the method comprising:
one of the slice switches divided from the physical switch receiving a packet;
applying a port-mapping table and identifying the slice switch receiving the packet and a corresponding virtual port, wherein the virtual port corresponds to a physical port of the physical switch;
parsing the packet for acquiring information of a destination and whether or not any VLAN tag is carried by the packet;
applying a VLAN conversion table to give the packet a VLAN tag if the packet has not carried a VLAN tag or replace the original VLAN ID in the packet with a new VLAN ID if the packet has carried the VLAN tag in accordance with the virtual port receiving the packet, wherein the VLAN tag records a VLAN ID;
applying an output port table and applying a flow rule to the packet for determining an output port according to the destination and the given VLAN ID; and
popping off the given VLAN tag from the packet if the packet originally has not carried a VLAN tag or restoring the modified VLAN ID back to its original VLAN ID if the packet originally has carried the VLAN tag, and outputting the packet via the output port.

2. The method as recited in claim 1, wherein the network topology is expanded by assembling multiple physical switches.

3. The method as recited in claim 1, wherein, if the packet entering the slice switch has already carried an original VLAN ID, the VLAN ID is provided to substitute the original VLAN ID; if the packet does not carry the original VLAN ID, the VLAN ID is given to the packet.

4. The method as recited in claim 3, wherein every slice switch is configured to have a range of multiple VLAN IDs, and the ranges of VLAN IDs are not overlapped among other slice switches.

5. The method as recited in claim 4, wherein the network topology is expanded by assembling multiple physical switches.

6. The method as recited in claim 1, wherein the flow rules of every slice switch are recorded into a bridging flow table in a memory of the physical switch.

7. The method as recited in claim 6, wherein the flow rule records an output port in response to the destination of the packet.

8. The method as recited in claim 7, wherein the network topology is expanded by assembling multiple physical switches.

9. A system for simulating a network topology using a physical machine, comprising:
a physical switch having multiple physical ports, the physical switch being divided into a plurality of slice switches according to a network topology, in which every slice switch includes a plurality of virtual ports and every virtual port corresponds to a physical port; wherein every slice switch simulates a node in a network, and every virtual port simulates a connection port of every node; and
a non-transitory storage medium storing a slice switch number for every slice switch and a virtual port number for every virtual port, comprising:
a port-mapping table configured to record numbers of multiple virtual ports of every slice switch and numbers of multiple physical ports of the physical switch; and
a VLAN conversion table configured to record a VLAN tag set to the slice switch where a packet enters, and store a VLAN ID, recorded in the VLAN tag, corresponding to every virtual port of every slice switch;
an output port table configured to record a destination of a packet and an output port given to the packet corresponding to the VLAN ID according to the destination; and
a pop-off VLAN-tag table configured to record the VLAN ID and an original VLAN ID corresponding to the packet.

10. The system as recited in claim 9, wherein the network topology is expanded by assembling multiple physical switches.

11. The system as recited in claim 9, wherein a quantity and numbers of the multiple virtual ports of every slice switch are dynamically changeable in response to the network topology.

12. The system as recited in claim 9, wherein the physical switch further comprises a management interface that is used to connect to a controller of the network topology, and the controller controls the multiple slice switches simulated by the physical switch according to the slice switch numbers.

13. The system as recited in claim 12, wherein the management interface is used to simulate a plurality of connections between the slice switches and the controller according to the number of the slice switches, and each connection is identified by a network ID.

14. The system as recited in claim 13, wherein the network topology forms a Software-Defined Network and the controller is specified to the Software-Defined Network.

15. The system as recited in claim 14, wherein the network topology is expanded by assembling multiple physical switches.

16. The system as recited in claim 9, wherein non-transitory storage medium stores a bridging flow table that is used to store the flow rules for every slice switch.

17. The system as recited in claim 16, wherein the network topology is expanded by assembling multiple physical switches.
